(19) United States
(12) Patent Application Publication
(10) Pub. No.: US 2010/0062409 A1
(43) Pub. Date: Mar. 11, 2010

(54) METHOD OF DEVELOPING AND PROVISIONING IT STATE INFORMATION OF COMPLEX SYSTEMS UTILIZING A QUESTION/ANSWER PARADIGM

(75) Inventor: Leonard S. Hand, Red Creek, NY (US)

Correspondence Address: Novak Druce + Quigg LLP, CityPlace Tower, 525 Okeechobee Blvd., Fifteenth-Floor, WEST PALM BEACH, FL, 33401, US

(73) Assignee: INTERNATIONAL BUSINESS MACHINES CORPORATION, Armonk, NY (US)

(21) Appl. No.: 12/207,709

(22) Filed: Sep. 10, 2008

(51) Int. Cl. G09B 7/00

(52) U.S. Cl. 434/322

(57) ABSTRACT

A system for providing and developing information technology status information for various assets is provided. The system can comprise one or more electronic data processors configured to process, display, and manage data. The system can further include a module configured to execute on the one or more electronic data processors. The module can be configured to enable a user to pose one or more questions pertaining to the status of a particular asset in the system. Additionally, the module can be configured to parse the one or more questions pertaining to the status of a particular asset. The module can be further configured to select and conduct one or more tests to determine an answer to the one or more questions. Moreover, the module can be configured to generate and display to the user the answer to the one or more questions.

### FIELD OF THE INVENTION

The present invention is related to the fields of data processing and autonomic computing, and more particularly, to techniques for indicating the status of information technology (IT) resources by using customizable sets of question-and-answer elements that arc particularly suited for non-technical users.

### BACKGROUND OF THE INVENTION

Within many of the myriad of IT environments that have developed in recent years there has been an ever-increasing demand for efficiency, optimization, virtualization, and return on investment. As a result, the internal complexity and interdependency of many IT environments has increased greatly.

Greater internal complexity and interdependency of an IT environment can make it extremely difficult for line-of-business (LoB) managers, service desk operators, application developers, and other IT professionals to readily determine, particularly in non-technical terms, the state or operating condition of an IT asset or series of related assets. It is thus often difficult for such professionals to isolate problems and render effective assistance to clients, especially in situations in which speed and reliability are paramount. Conventional software solutions typically offer a user a sub-optimal choice among a generalized dashboard interface with some limited drill-down capabilities, very specific tools that tend to overwhelm all but the most technically savvy user, or management platforms that merely correlate events based on monitoring.

As a result, there is a need for more efficient and effective systems for indicating the status of IT resources and assets through the use of a question-and-answer approach, which ensures an intuitive and user-friendly experience for users.

### SUMMARY OF THE INVENTION

The present invention is directed to systems and methods for providing and developing IT status information for a variety of assets contained within a particular system. A tool utilizing the following question-and-answer approach can be represented in simple “human” terms and can provide value, easy setup, and customization.

One embodiment of the invention is a system for providing and developing information technology status information for various assets. The system can comprise one or more electronic data processors configured to process, display, and manage data. The system can further include a module configured to execute on the one or more electronic data processors. The module can be configured to enable a user to pose one or more questions pertaining to the status of a particular asset in the system. Additionally, the module can be configured to parse the one or more questions pertaining to the status of a particular asset. The module can be further configured to select and conduct one or more tests to determine an answer to the one or more questions posed. Moreover, the module can be configured to generate and display to the user the answer to the one or more questions.

Another embodiment of the invention is a computer-based method for providing and developing information technology status information for various assets in a system. The method can include enabling a user to pose one or more questions pertaining to the status of a particular asset in the system. Additionally, the method can include parsing the one or more questions pertaining to the status of a particular asset. The method can also include selecting and conducting one or more tests to determine an answer to the one or more questions posed. Furthermore, the method can include generating and displaying to the user the answer to the one or more questions.

Yet another embodiment of the invention is a computer-readable storage medium that contains computer-readable code, which when loaded on a computers causes the computer to perform the following steps: enabling a user to pose one or more questions pertaining to the status of a particular asset in the system; parsing the one or more questions pertaining to the status of a particular asset; selecting and conducting one or more tests to determine an answer to the one or more questions posed; and, generating and displaying to the user the answer to the one or more questions.

### BRIEF DESCRIPTION OF THE DRAWINGS

There are shown in the drawings, embodiments which are presently preferred. It is expressly noted, however, that the invention is not limited to the precise arrangements and instrumentalities shown.

FIG. 1 is a schematic view of a system for providing and developing information technology status information for various assets, according to one embodiment of the invention.

FIG. 2 is a schematic diagram illustrating the basic layering of the system for providing status information for various assets.

FIG. 3 is a screen depicting tests, corresponding answers to the tests, and the confidence level in the tests.

FIG. 4 is an illustration of a graphical user interface for posing questions.

FIG. 5 is an example of a 3d simulation utility which enables user interaction.

FIG. 6 is an example of an aggregated mash-up in a dashboard utility.

FIG. 7 is an illustration of a screen depicting the retrieval of cached and stored answers.

FIG. 8 is a flowchart of steps in a method for providing and developing information technology status information for various assets, according to another embodiment of the invention.

### DETAILED DESCRIPTION

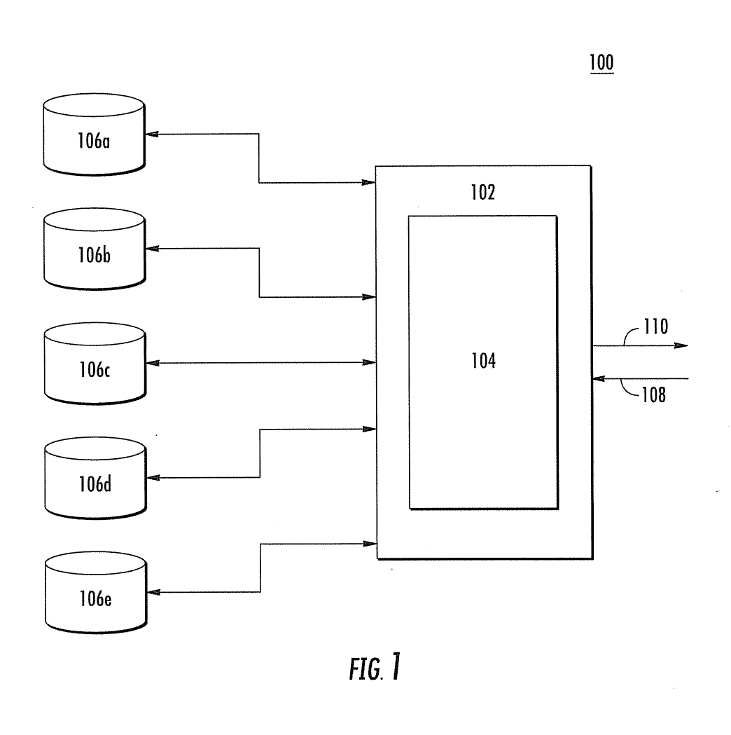

Referring initially to FIG. 1, a system 100 for providing and developing information technology status information of various assets, according to one embodiment of the invention, is schematically illustrated. The system 100 can include one or more electronic data processors 102 configured to process, display, and manage data. Optionally, the system 100 can further include one or more databases 106a-e configured to store data, wherein the one or more databases 106a-e are communicatively linked to the one or more electronic data processors 102. Additionally, the system 100 can include an input 108 and an output 110. Although one electronic data processor 102, five databases 106a-e, one input 108, and one output 110 are shown, it will be apparent to one of ordinary skill based on the description that a greater or fewer number of databases 106a-e and a greater number of electronic data processors 102, inputs 108, and outputs 110 can be utilized.

The system 100 further includes a module 104, which, can be implemented as computer-readable code configured to execute on the one or more electronic data processors 102. The module 104 can also be communicatively linked to the one or more optional databases 106a-c. Alternatively, the module 104 can be implemented in hardwired, dedicated circuitry for performing the operative functions described herein. In yet another embodiment, however, the module 104 can be implemented in a combination of hardwired circuitry and computer-readable code.

Operatively, the module 104 can be configured to enable a user to pose one or more questions as inputs 108 pertaining to a status of a particular asset in the system. For example, a user may ask “Are the printers online?” or “Is web server A operational?” to find out the status of the printers and server in the system. The module 104 can be additionally configured to parse the one or more questions pertaining to the status of a particular asset. The module 104 can also be configured to select and conduct one or more tests to determine an answer to the one or more questions posed. In trying to answer “Is web server A operational?,” the module 104 can conduct a test that pings web server A by using Internet Control Message Protocol (ICMP) packets. Furthermore, the module 104 can be configured to generate and display to the user the answer 110 to the one or more questions.

In a particular embodiment of the system 100, the one or more questions can comprise a sequence of sub-questions, which collectively pertain to the status of the particular asset and are utilized in determining the answer to the one or more questions. For example, the question “Is web server A operational?” could really involve asking sub-questions such as “Can I ping web server A?” and “Can I perform an HTTP GET of various objects?” when trying to determine whether or not web server A is operational.

Additionally, the one or more tests can comprise a sequences of sub-tests, wherein the sub-tests are conducted to generate answers to the sub-questions. Using the previous example, a ping test (ICMP) can be used to determine the sub-question pertaining to whether or not one can ping web server A. Furthermore, the answer to the one or more questions and the answers to the sub-questions can include confidence levels. The confidence level can indicate the likelihood that the one or more tests and the one or more sub-tests answer the one or more questions. As an example, the confidence level can be expressed as a percentage, wherein the percentage indicates the level of confidence the particular test provides in answering a particular question posed.

The one or more tests and sub-tests can include, but are not limited to, one or more tests such as pinging a system (ICMP), forward and reverse resolution of a domain name system, URL web requests, web services requests, calling remote programs, logging of results, reporting on logged tests, reporting on an individual test, providing alert messages, providing supporting information, indicating confidence levels, and pre-checking before any checks are performed.

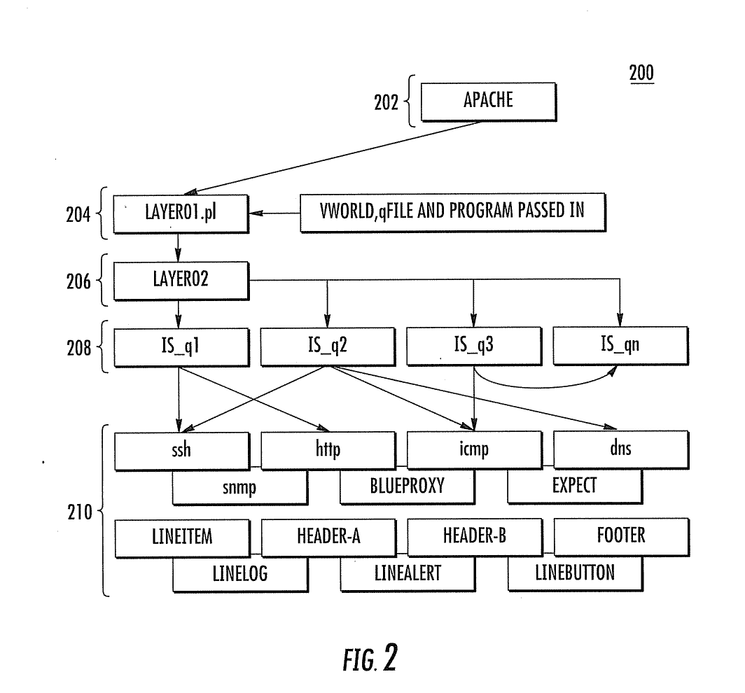

Referring now also to FIG. 2, a schematic diagram illustrating the basic layering of a system 200 for providing status information for various assets is depicted. The system 200 can include having requests come in via a web server 202. The requests can be processed at the question layer 204. For example, the request can be “What is the status of the name server?” After processing the request, the display layer 206 can dictate all of the semantics for controlling the display of the various questions, tests, and answers. Subsequently, the test language layer 208 contains the sequence of questions that need to be answered in order to response to the original request, which asked “What is the status of the name server?”. The test language layer 208 can call upon a variety of tests 210, including utility tests, that are defined within the system 200. These tests 210 are conducted and the answers to the question are displayed to a user of the system 200.

According to another embodiment of the system 100, the module 104 can be configured to present the user with one or more of a list of status messages, one or more tests and corresponding answers, sub-tests and corresponding answers, and recommendations to conduct more tests. As an example, a user can pose the question “Is web server A operational?” and have the system 100 run a series of tests to answer the question. The system 100 could run a predefined test that checks to see whether the network is operational. However, the predefined test may end up returning a confidence level of only 10%. As a second test, the system 100 could run another test which pings web server A that returns a higher confidence level of 40%. This in and of itself might not be a complete test as the confidence level is probably too low to be useful to a user. At this point the system 100 could recommend that the user conduct a series of other tests, which, if conducted, could raise the confidence level.

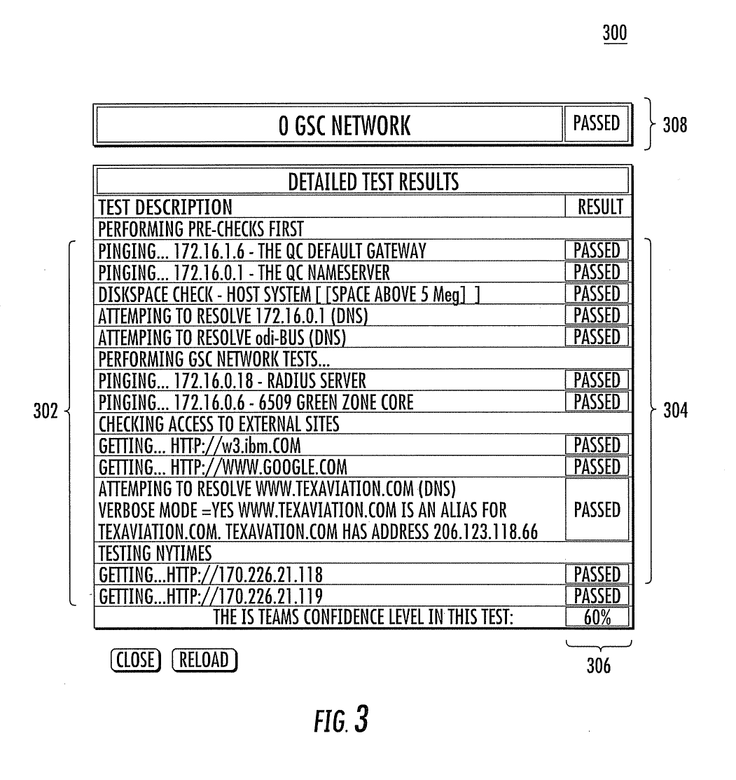

Referring now also to FIG. 3, a screen 300 depicting tests, answers to the tests, and confidence levels is shown. The screen 300 can display and present a series of tests and sub-tests 302 which are conducted to determine the answer to a question regarding the status of a particular asset. Additionally, the screen 300 can depict the answers 304 to the tests and sub-tests 302. Also displayed is the confidence level 306 in the tests and sub-tests 302, which, in this case, is a percentage. The screen 300 further includes an answer 308 pertaining to the status of the particular asset inquired about.

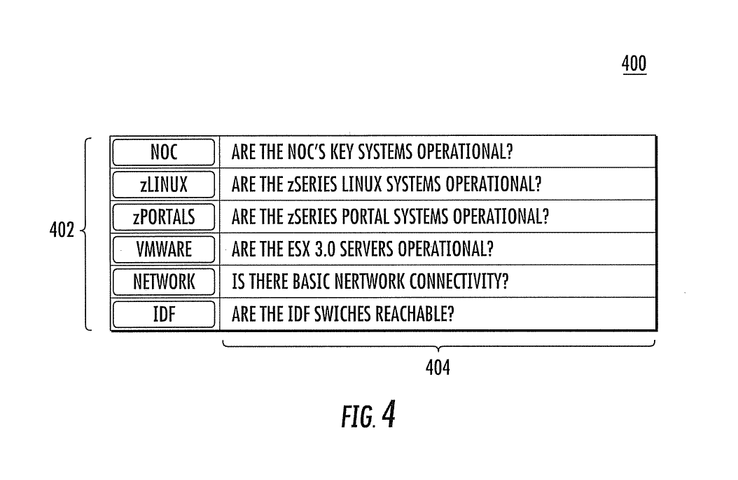

According to yet another embodiment, the module 104 can be configured to enable the user to interact with the one or more questions, one or more tests, sub-questions, and sub-tests through one or more among a graphical user interface application, graphical tools, a web-page application, a 3d simulation, aggregated mash-ups in a dashboard utility, and a portal setup. Referring now also to FIG. 4, a graphical user interface 400 for posing questions, is illustrated. The interface 400 can include a series of selectable buttons 402, which correspond to a series of questions 404 pertaining to the status of various assets in the system 100. A user can select one or more of the buttons 402, which prompt the system to run the tests necessary for answering the questions 404.

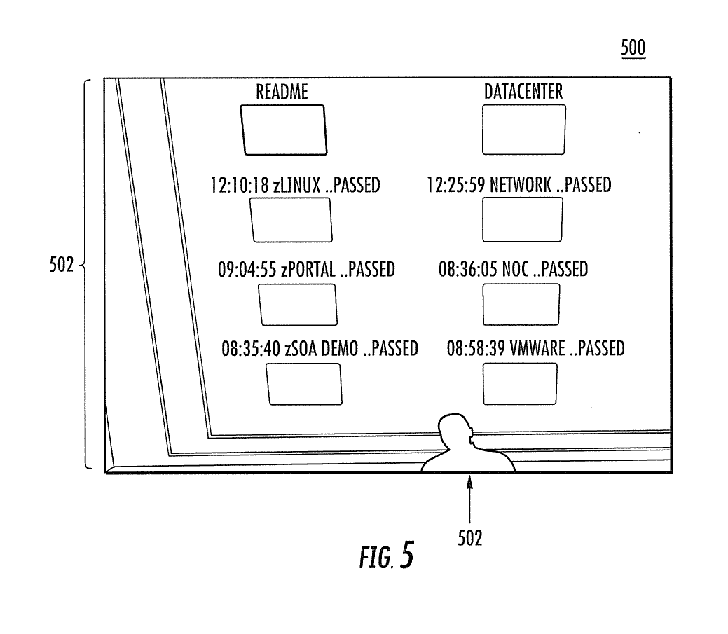

Referring now also to FIG. 5, an example of a 3d simulation utility 500, which enables user interaction is shown. The 3d simulation utility 500 can include a user 502 who poses questions to the system 100. After posing the desired questions, the user 502 can view the various tests and corresponding answers 504 in the 3d simulation utility 500. The 3d simulation utility 500 can further include graphical tools for linking various questions and tests together such as through a drag-and-drop mechanism (not explicitly shown). Such a utility allows for a broad view of the status of various assets within the system 100, and it can be used by even the most inexperienced users 502.

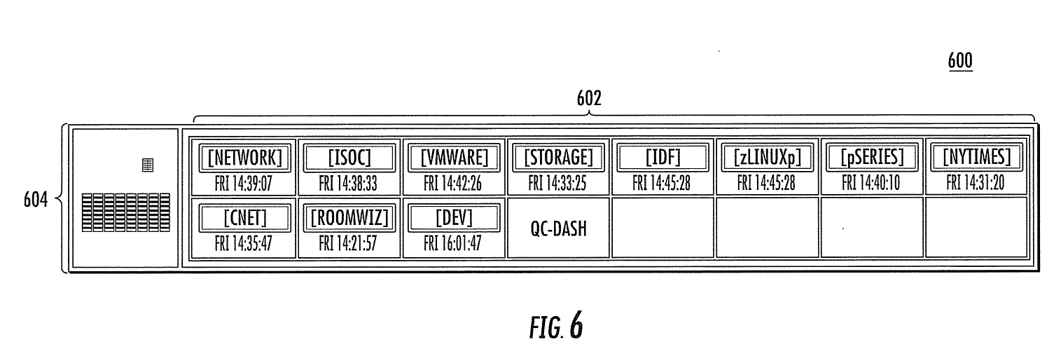

In another embodiment, the module 104 can be configured to perform one or more additional tests based upon a schedule. The module 104 can be also configured to provide an audio signal representative of an answer to the one or more questions. Referring now also to FIG. 6, an example of an aggregated mash-up in a dashboard utility 600 is illustrated. The dashboard 600 can include a series of tests 602. Once a set of tests 602 are selected, the system 100 can conduct the tests and generate the answers (not explicitly shown). The dashboard 600 can display the answers to the tests 602, which are conducted by the module 104. The dashboard 600 not only enables easy viewing of the status of various assets, but is an easy-to-use interface for users with its column and row layout.

Additionally, the dashboard 600 can perform one or more tests according to a schedule and provide an audio signal indicative of an answer to a question posed. For example, if a user would like to conduct the same set of tests every five minutes, the module 104 can automatically conduct the same tests every five minutes without the user having to keep selecting the tests. After conducting the tests, the dashboard 600 can inform the user of the answer to the one or more questions through the use of voice response or through the display screen 604. The dashboard 600 can also indicate the last time a particular test was conducted.

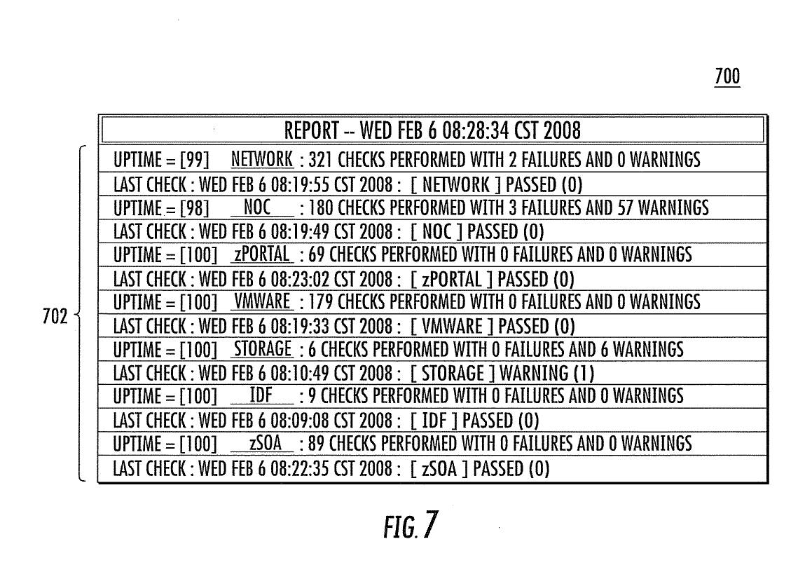

In yet another embodiment, the module 104 can be configured to cache and store the generated answer to the one or more questions. Also, the cached and stored answer can be transmitted to the one or more optional databases 106a-e for storage. The cached and stored answer can be retrieved by a subsequent user without having to conduct an additional test in the system 100. Referring now also to FIG. 7, an illustration of screen 700 depicting the retrieval of cached and stored answers is provided. The screen 700 includes answers 702 to questions and sub-questions posed at a prior time. In this case, for example, a network test was conducted on Feb. 6, 2008 with an answer of “passed.” If a user is requesting an answer to a particular question that was already posed recently, it is particularly useful and relevant to the user if the user can retrieve the answer 702. This is because a recently stored and cached answer 702 can be highly indicative of the current status of a particular asset.

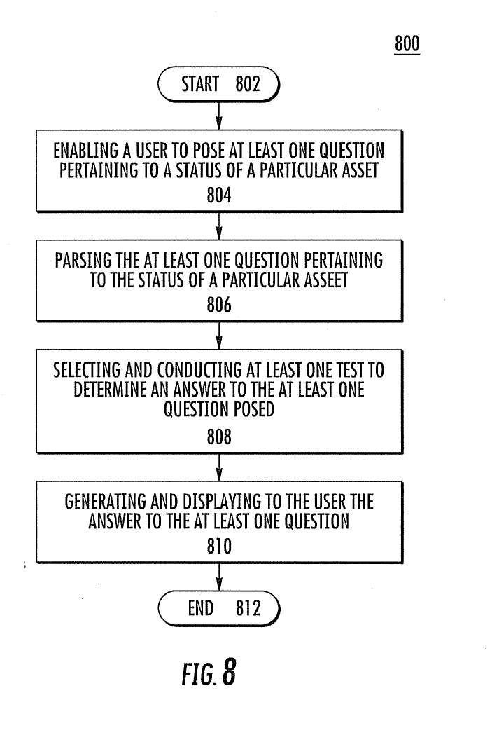

Referring now to FIG. 8, a flowchart is provided that illustrates certain method aspects of the invention. The flowchart depicts steps of a method 800 for providing and developing information technology status information of various assets in a system. The method 800 illustratively includes, after the start step 802, enabling a user to pose one or more questions pertaining to a status of a particular asset in the system at step 804. Additionally, the method 800 can include parsing the one or more questions pertaining to the status of a particular asset at step 806. The method 800 also can include selecting and conducting one or more tests to determine an answer to the one or more questions posed at step 808. At step 810, the method 800 can further include generating and displaying to the user the answer to the at least one question. The method 800 illustratively concludes at step 812.

The one or more questions can comprise a sequence of sub-questions, which collectively pertain to the status of the particular asset and are utilized in determining the answer to the one or more questions. Additionally, the one or more tests can comprise a sequences of sub-tests, wherein the sub-tests are conducted to generate answers to the sub-questions. Furthermore, the answer to the one or more questions and the answers to the sub-questions can include confidence levels. The confidence level can indicate the likelihood that the one or more tests and the one or more sub-tests answer the one or more questions. The one or more tests and sub-tests can include, but are not limited to, one or more tests such as pinging a system, forward and reverse resolution of a domain name system, URL web requests, web services requests, calling remote programs, logging of results, reporting on logged tests, reporting on an individual test, providing alert messages, providing supporting information, indicating confidence levels, and pre-checking before any checks are performed.

According one embodiment, the method 800 can further include, at the generating and displaying step 810, presenting the user with one or more of a list of status messages, one or more tests and corresponding answers, sub-tests and corresponding answers, confidence levels, and recommendations to conduct more tests. In another embodiment, the method 800 can include enabling the user to interact with the one or more questions, one or more tests, sub-questions, and sub-tests through one or more among a graphical user interface application, graphical tools, a web-based application, a 3d simulation, aggregated mash-ups in a dashboard utility, and a portal setup.

In yet another embodiment, the method 800 can include caching and storing the generated answer to the one or more questions. The cached and stored answer can be retrieved by a subsequent user without having to conduct an additional test in the system. The method 800 can also include performing one or more additional tests based upon a schedule. According to another embodiment, the method 800 can further include providing an audio signal representative of an answer to the one or more questions.

The invention, as already mentioned, can be realized in hardware, software or a combination of hardware and software. The invention can be realized in a centralized fashion in one computer system, or in a distributed fashion where different elements are spread across several interconnected computer systems. Any type of computer system or other apparatus adapted for carrying out the methods described herein is appropriate. A typical combination of hardware and software can be a general purpose computer system with a computer program that, when being loaded and executed, controls the computer system such that it carries out the methods described herein.

The invention, as already mentioned, can be embedded in a computer program product, such as magnetic tape, an optically readable disk, or other computer-readable medium for storing electronic data. The computer program product can comprise computer-readable code, defining a computer program, which when loaded in a computer or computer system causes the computer or computer system to carry out the different methods described herein. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

The preceding description of preferred embodiments of the invention have been presented for the purposes of illustration. The description provided is not intended to limit the invention to the particular forms disclosed or described. Modifications and variations will be readily apparent from the preceding description. As a result, it is intended that the scope of the invention not be limited by the detailed description provided herein.

We claim:

1. A computer-based method for providing and developing information technology status information of various assets in a system, the method comprising:
enabling a user to pose at least one question pertaining to a status of a particular asset in the system;
parsing the at least one question pertaining to the status of a particular asset;
selecting and conducting at least one test to determine an answer to the at least one question; and
generating and displaying to the user the answer to the at least one question.

2. The method of claim 1, wherein the at least one question can comprise a sequence of sub-questions, wherein the sub-questions collectively pertain to the status of the particular asset and are utilized in determining the answer to the at least one question.

3. The method of claim 2, wherein the at least one test can comprise a sequence of sub-tests, wherein the sub-tests are conducted to generate answers to the sub-questions.

4. The method of claim 3, wherein the answer to the at least one question and answers to the sub-questions include confidence levels, wherein the confidence level indicates the likelihood that the at least one test and at least one sub-test answer the at least one question.

5. The method of claim 3, wherein the at least one test and sub-tests comprise at least one among tests for pinging a system, forward and reverse resolution of a domain name system, URL web requests, web services requests, calling remote programs, logging of results, reporting on logged tests, reporting on an individual test, providing alert messages, providing supporting information, indicating confidence levels, and pre-checking before any checks are performed.

6. The method of claim 4, wherein the generating and displaying step, the user is presented with at least one of a list of status messages, at least one test and corresponding answers, sub-tests and corresponding answers, the confidence levels, and recommendations to conduct more tests.

7. The method of claim 3, further comprising enabling the user to interact with the at least one question, at least one test, sub-questions, and sub-tests through at least one among a graphical user interface application, graphical tools, a web-based application, a 3d simulation, aggregated mash-ups in a dashboard utility, and a portal setup.

8. The method of claim 1, further comprising caching and storing the generated answer to the at least one question, wherein the cached and stored answer can be retrieved by a subsequent user without having to conduct an additional test in the system.

9. The method of claim 1, further comprising performing at least one additional test based upon a schedule.

10. The method of claim 1, further comprising providing an audio signal representative of an answer to the at least one question.

11. A computer-based system for providing and developing information technology status information of various assets, the system comprising:
at least one electronic data processor configured to process, display, and manage data;
a module configured to execute on the at least one electronic data processor, wherein the module is configured to:
enable a user to pose at least one question pertaining to a status of a particular asset in the system;
parse the at least one question pertaining to the status of a particular asset;
select and conduct at least one test to determine an answer to the at least one question posed; and
generate and display to the user the answer to the at least one question.

12. The system of claim 11, wherein the at least one question can comprise a sequence of sub-questions, wherein the sub-questions collectively pertain to the status of the particular asset and are utilized in determining the answer to the at least one question.

13. The system of claim 12, wherein the at least one test can comprise a sequence of sub-tests, wherein the sub-tests are conducted to generate answers to the subquestions.

14. The system of claim 13, wherein the answer to the at least one question and answers to the sub-questions include confidence levels, wherein the confidence level indicates the likelihood that the at least one test and at least one sub-test answer the at least one question.

15. The system of claim 13, wherein the at least one test and sub-tests comprise at least one among tests for pinging a system, forward and reverse resolution of a domain name system, URL web requests, web services requests, calling remote programs, logging of results, reporting on logged tests, reporting on an individual test, providing alert messages, providing supporting information, indicating confidence levels, and pre-checking before any checks are performed.

16. The system of claim 14, wherein the module is configured to present the user with at least one of a list of status messages, at least one test and corresponding answers, sub-tests and corresponding answers, the confidence levels, and recommendations to conduct more tests.

17. The system of claim 13, wherein the module is configured to enable the user to interact with the at least one question, at least one test, sub-questions, and sub-tests through at least one among a graphical user interface application, graphical tools, a web-based application, a 3d simulation, aggregated mash-ups in a dashboard utility, and a portal setup.

18. The system of claim 11, wherein the module is configured to cache and store the generated answer to the at least one question, wherein the cached and stored answer can be retrieved by a subsequent user without having to conduct an additional test in the system.

19. The system of claim 18, further comprising at least one database configured to store data and the cached and stored answer from the module, wherein the at least one database is communicatively linked to the at least one electronic data processor and module.

20. The system of claim 11, wherein the module is configured to perform at least one additional test based upon a schedule.

21. The system of claim 11, further comprising providing an audio signal representative of an answer to the at least one question.

22. A computer-readable storage medium having stored therein computer-readable instructions, which, when loaded in and executed by a computer causes the computer to perform the steps of:
enabling a user to pose at least one question pertaining to a status of a particular asset in the system;
parsing the at least one question posed pertaining to the status of a particular asset;
selecting and conducting at least one test to determine an answer to the at least one question posed; and
generating and displaying to the user the answer to the at least one question.

23. The computer-readable storage medium of claim 22, wherein the at least one question can comprise a sequence of sub-questions, wherein the sub-questions collectively pertain to the status of the particular asset and are utilized in determining the answer to the at least one question.

24. The computer-readable storage medium of claim 23, wherein the at least one test can comprise a sequence of sub-tests, wherein the sub-tests arc conducted to generate answers to the sub-questions.

25. The computer-readable storage medium of claim 24, wherein the answer to the at least one question and answers to the sub-questions include confidence levels, wherein the confidence level indicates the likelihood that the at least one test and at least one sub-test answer the at least one question.

26. The computer-readable storage medium of claim 24, wherein the at least one test and sub-tests comprise at least one among tests for pinging a system, forward and reverse resolution of a domain name system, URL web requests, web services requests, calling remote programs, logging of results, reporting on logged tests, reporting on an individual test, providing alert messages, providing supporting information, indicating confidence levels, and pre-checking before any checks are performed.

27. The computer-readable storage medium of claim 25, wherein the generating and displaying step, the user is presented with at least one of a list of status messages, at least one test and corresponding answers, sub-tests and corresponding answers, the confidence levels, and recommendations to conduct more tests.

28. The computer-readable storage medium of claim 24, further comprising enabling the user to interact with the at least one question, at least one test, sub-questions, and sub-tests through at least one among a graphical user interface application, graphical tools, a web-based application, a 3d simulation, aggregated mash-ups in a dashboard utility, and a portal setup.

29. The computer-readable storage medium of claim 22, further comprising caching and storing the generated answer to the at least one question, wherein the cached and stored answer can be retrieved by a subsequent user without having to conduct an additional test in the system.

30. The computer-readable storage medium of claim 22, further comprising performing at least one additional test based upon a schedule.

31. The computer-readable storage medium of claim 22, further comprising providing an audio signal representative of an answer to the at least one question.
